(19) United States
(12) Patent Application Publication
(10) Pub. No.: US 2011/0070062 A1
(43) Pub. Date: Mar. 24, 2011

(54) TRANSPORT CONTAINER

(76) Inventors: Jon Michael Thompson, Collierville, TN (US); Greggory L. Hobby, Bartlett, MN (US); Joseph D. Oliver, Engelwood, OH (US)

(21) Appl. No.: 12/743,897

(22) PCT Filed: Nov. 20, 2008
(86) PCT No.: PCT/US08/84162

§ 371 Date: Dec. 8, 2010

Related U.S. Application Data
(60) Provisional application No. 60/989,348, filed on Nov. 20, 2007.

(51) Int. Cl. B60P 3/22; B65D 25/14

(52) U.S. Cl. 414/800; 220/495.01

(57) ABSTRACT

A transport container inside an insulating shell is described.

### TECHNICAL FIELD

This invention relates to transport containers, and more particularly to a transport container including a flexible inner tank inside an insulating shell.

### BACKGROUND

Fluids may be shipped by a variety of methods, including using truck and railcars. Typically, stainless steel containers are used for shipping fluids. Some fluids are perishable and require keeping the fluid at a certain temperature or within a range of temperatures during shipment. Other fluids may thicken or solidify during shipment or at ambient temperature, and require an increased temperature for loading and unloading. It may be beneficial for other materials to remain within a desired temperature range for other reasons as well. In these cases, insulated shipping containers may be used. A heating and/or cooling apparatus or material may also be associated with the insulated shipping containers to maintain the desired temperature.

In the case of stainless steel tanker trucks or lined railcars, after each shipment, the insulated stainless steel container may be washed and sterilized. This is done to remove any potential contamination from the shipping container and to fully prepare it for the next shipment. This washing is usually conducted at a specialized washing facility because of the equipment required, as well as for safety and environmental reasons. There is a need for a transport container that requires minimal washing, sanitizing, thermally insulated, and is reusable/recyclable.

### SUMMARY

In one aspect, an apparatus for the transport of materials is provided. Such an apparatus includes a tank having a top surface, a bottom surface, a cavity, and an access port; a flexible bag comprising a check valve assembly, wherein the flexible bag can be positioned inside the cavity of the tank such that the check valve assembly is able to be accessed from the tank's access port; an insulating shell adjacent to the tank; a bulkhead assembly providing structural support to the tank; and a temperature control unit for controlling the temperature of the materials. Such an apparatus can further include an outer shipping container.

In one embodiment, the bulkhead assembly comprises a door. In one embodiment, the check valve assembly is removable. In certain instances, the check valve assembly is washable. In certain instances, the check valve assembly is sealable. In certain instances, the check valve assembly is affixed to the bag. The flexible bag can be made from polypropylene, polyethylene, or other polymeric material. In one embodiment, the flexible bag has a single layer construction; in other embodiments, the flexible bag has a multi-layer construction. A flexible bag as used in the present apparatus can hold, for example, 5,000 to 25,000 liters of fluid.

It is a feature of the invention that the flexible bag can be reusable and/or recyclable. In certain instances, the tank is rigid; in other instances, the tank is semi-rigid. In one embodiment, the insulating shell is permanently affixed to the tank. In another embodiment, the insulating shell is removably attached to the tank. In certain embodiments, the insulating shell is flexible; alternatively, the insulating shell is rigid. In one embodiment, the temperature control unit comprises a heating mechanism. In one embodiment, the heating mechanism is a heating pad or a plurality of heating pads. In one embodiment, the temperature control unit comprises a cooling mechanism.

In another aspect, an apparatus for transporting corn syrup is provided. Such an apparatus typically includes a rigid tank having a top surface, a bottom surface, a cavity, and an access port located at or near the bottom surface; a flexible bag comprising a check valve assembly, wherein the flexible bag can be positioned inside the cavity of the tank such that the check valve assembly is able to be accessed from the tank's access port; a removable foam insulating shell applied to the exterior of the tank; a bulkhead assembly providing structural support to the tank; and a temperature control unit comprising one or more heating elements for controlling the temperature of the materials.

In another aspect, a process for transporting material is provided. Such a process typically includes filling the flexible bag of the apparatus of claim 1 with a material via the check valve assembly; placing the apparatus on a chassis; transporting the apparatus to a delivery location; and unloading the material from the flexible bag via the check valve assembly. Representative materials include corn syrup, high fructose corn syrup, soybean oil, corn oil, and industrial oils.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic showing one embodiment of a transport container.

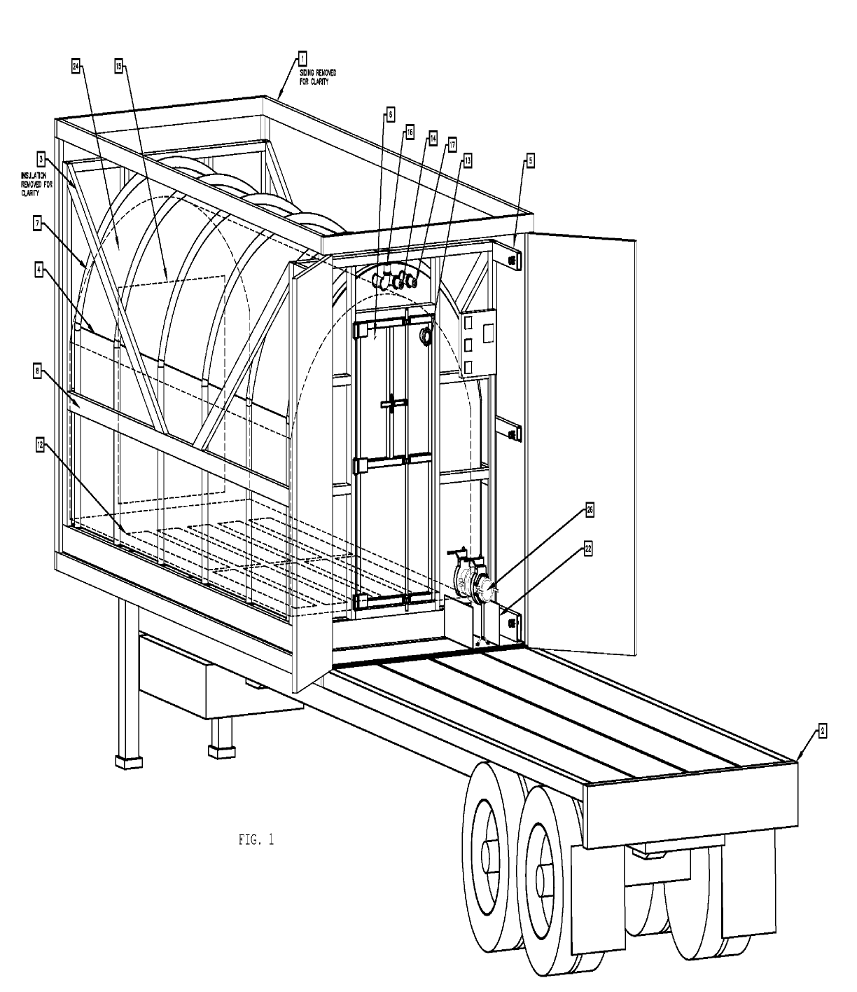

FIG. 2 is a schematic showing one embodiment of a check valve.

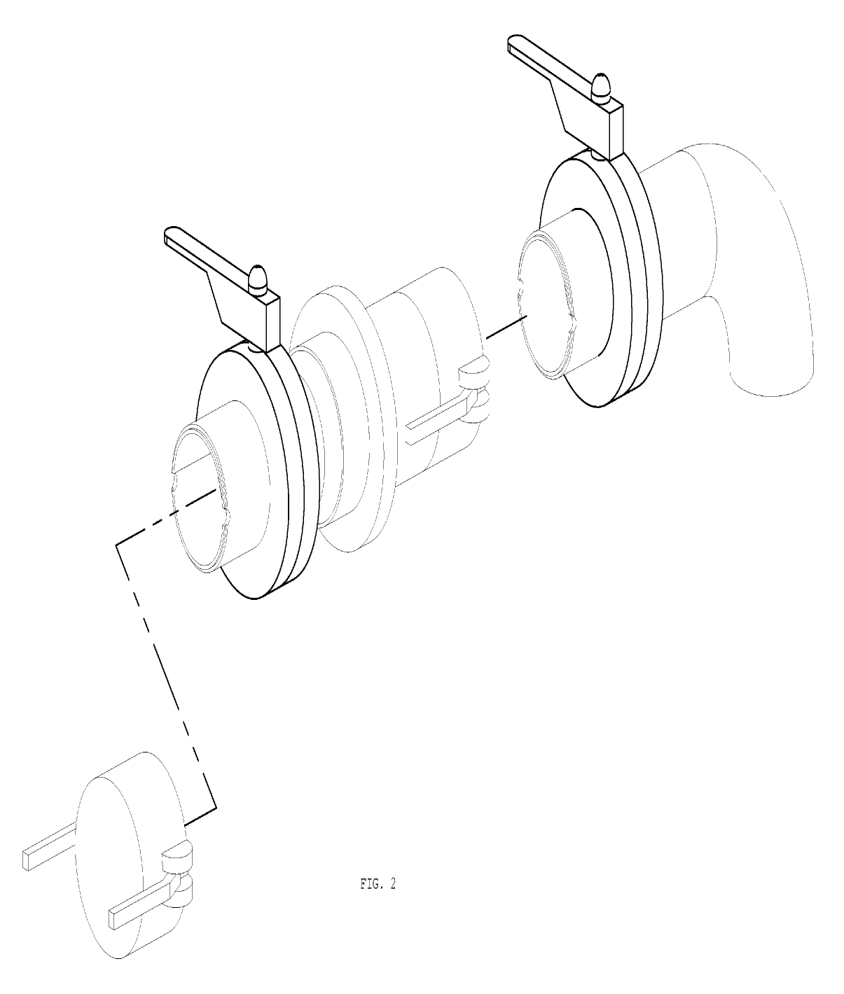

### DETAILED DESCRIPTION

An apparatus for transporting materials is described herein. The apparatus typically includes a tank, a flexible bag placed inside the tank having a check valve assembly, an insulating shell surrounding the tank and a temperature control device that allows for the material to be maintained at a desired temperature. Any number of materials can be transported using a transport container such as those described herein. For example, a material may be a fluid. Fluids include liquids, food grade liquids and other flowable materials. Crystallized liquids or materials having a high degree of fluidity such as crystallized solids may also be transported in such a container. Examples of suitable fluids include, without limitation, corn syrup, high fructose corn syrup, soybean oil, corn oil, and other oils (e.g., industrial oils).

The flexible bag 24 may be made from a plastic, or other pliable material. For example, the tank may be formed of polyethylene, polypropylene, polyurethane, nitrol rubber, or a blend of the materials above. The flexible bag may be formed of a single layer or multiple layers. In a multi-layer configuration, the layers may all be formed of the same material, or the layers may be formed of different materials. In one embodiment the flexible bag is constructed using a fabric material overlayed with a plastic material. Typically, the flexible bag can hold materials ranging from 5,000 to 25,000 liters. In one embodiment, the flexible bag can hold up to about 16,000 liters.

The flexible bag generally includes a check valve assembly 26. Typically, a check valve assembly used in a transport container as described herein is a one-way check valve but, alternatively, a block valve can be used. The check valve assembly provides for a closed system, which ensures that no contaminating material can enter the bag after loading. Examples of contamination any type of foreign material, including but not limited to chemicals and/or microbiological organisms. A one-way check valve assembly also prevents back-flow (also known as back flushing), which also can cause contamination. The check valve assembly may be removable from the flexible bag and can be washable and sanitizable. In addition, the check valve assembly can be sealable, which can reduce the potential for outside contamination during shipment.

The apparatus also includes a tank 4, within which one or more flexible bags can be placed. In some embodiments, the tank may be rigid or semi-rigid, and can be made from aluminum, steel, stainless, steel, fiberglass, polyethylene, polypropylene, polyurethane, nitrol rubber, structural foam, or any combination thereof. The tank is designed to have an access port 11 located at or near the bottom of the tank such that the check valve on the flexible bag can be accessed. Having the outlet of the tank located at or near the bottom of the tank and insulating shell can facilitate loading and unloading of the material. Such a configuration enables full unloading of the material via gravity, without using unloading assists such as pumping compressed air into the flexible bag.

The insulating shell 3 forms an insulating enclosure around the tank. In one embodiment, the insulating shell may comprise spray foam 9, padding, an insulating jacket, or some other form of insulation either as one single unit or in multiple units. The insulating shell may be flexible, rigid, or semi-rigid, and may be removable or permanently affixed to the tank.

An apparatus as described herein generally is equipped with a temperature control device 18, which can include temperature sensors 19. A temperature control device can include one or more heating or cooling elements 12. The heating or cooling elements can be attached to or can be a part of an insulating shell or a tank, which can have a plug-in 23 for the heating or cooling element. In one embodiment, one or more heating elements are placed between a tank and an insulating shell. A heating element can be used to re-heat or maintain an elevated temperature (above the surrounding air temperature) of the material within the bag. Heating elements can include, for example, electrical heating elements, water or steam heating elements, microwave heating elements, or heating elements that utilize conduction or convention. In some embodiments, the heating element is a heating pad (e.g., an electric heater using 110 V). A temperature control device also can include a cooling device to cool or maintain a depressed temperature (below the surrounding air temperature) of the material. Cooling elements can include, for example, cooled liquid or gas, gel packs or solid carbon dioxide.

The apparatus for transporting material also can include a bulkhead assembly 5 to stabilize the apparatus during transport. For example, the bulkhead assembly can prevent the insulating shell from moving and shifting. The bulkhead assembly meets all Department of Transportation standards. The bulkhead assembly may be constructed from metal, wood, plastic, or a combination of these materials. The bulkhead assembly may also have a bulkhead access door 6 for easy and quick access to the inside of the insulating shell so that the bag can be accessed for inspection, repair, or replacement, for example. The bulkhead assembly may be attached to supports or structural hoops 7 and a rub bar 8 to provide strength and protection. Further, in some embodiments, the bulkhead assembly structure is insulated and in some embodiments, the structure has an ultra-violet protective coating. In some embodiments, a bull board 10, or a rigid fixture situated between the bulkhead and the bag is used to prevent the bag from deforming while the bulkhead door is open.

In some embodiments, various components of the transport container apparatus may be equipped with a sight glass 13, a light 14, a mirror 15, a leak detection mechanism 20 or pressure protection device 16, wash down pan 21, a drip pan 22, and other components used to detect and moniter the integrity of the materials being transported. An apparatus as described herein also can include a high level probe 17.

The transport container apparatus can be placed inside a shipping container 1 that is sized to fit on an appropriate transport chassis 2. The shipping container may be a range of sizes. For example, the typical shipping container may be the size of a standard 20-foot shipping container (ISO standard), or the shipping container could be a smaller size, such as a 10 foot container, or a larger size, such as would fit on a rail car chassis. In some embodiments, the shipping container is 40 feet, 45 feet, 48 feet, 53 feet, or sized to fit on a van trailer or flat bed. The shipping container can be used to protect the tank, the insulating shell and the flexible bag. The shipping container may be used to make shipment easier, such as by making the overall shipment a standard size and making it easier to transfer transportation modes (such as truck to ship, rail to truck, etc.). The shipping container may also be used for designation and/or advertising purposes. The apparatus (e.g., within a shipping container) can be placed on a chassis for transporting. Various chassis may be used. Typically, a standard truck chassis, or a flatbed car chassis may be used for transport. Other chassis may also be used. For example, a smaller truck chassis may be used for smaller loads or a rail car chassis can be used for larger loads.

One benefit of the apparatus described herein is that the flexible bag is completely sealed from external contamination. Contamination occurs when any foreign or unwanted product or biological organisms enters the system. In many current designs, the top of the container is open, and it is possible for contamination to enter the system during loading or unloading, sometimes even when proper care is taken. The completely closed flexible bag prevents this type of contamination by design. In addition, with current designs, contaminants may be present on the inside of a shipping container, for example, if the container was not properly or completely washed after the prior shipment. The combination of some existing containers and washing systems also may make a complete washing very difficult. The transport container described herein also has little or no air present or headspace, as in other shipping containers, which removes another potential source of contamination. Another benefit of the apparatus described herein is that the flexible bag can last for multiple shipments prior to being replaced. The tank may last for at least 10 trips. In some embodiments the tank may last for 20, 30 or more trips before replacement is necessary.

The apparatus described herein has relatively low associated costs, which can lead to better replacement decisions. Additional benefits include a reduction in energy and energy waste due to a reduction in the need to wash the railcars. In addition, the apparatus described herein is adaptable to any number of transport systems (e.g., railcar, semi-trailer, etc.), which can reduce transportation costs and decrease the dependency on rail.

### EXAMPLE

### Example 1

A tank made from a single layer polypropylene is installed within an insulating shell. The tank and insulating shell is placed within a 20 foot shipping container, and placed on a chassis. The inlet/outlet of the tank is placed near the bottom of the insulating shell. The tank is loaded with high fructose corn syrup to the designated weight of the system. After completing the loading and disconnecting the loading line, a sanitized check valve assembly is installed on the outlet of the tank and sealed in place. The bulkhead assembly doors are then sealed. The tank and chassis are then connected to a truck and shipped to a customer.

At the delivery location, the container doors are opened. A sample may be obtained from the check valve assembly. After passing any quality checks, the customer unloading hose may be connected to the check valve assembly, and the contents unloaded. After unloading, the container doors are sealed, and the tank and chassis are sent back to the loading facility.

The loading facility opens the container doors, and removes the check valve assembly. The tank is then reloaded with corn syrup, and a sanitized check valve assembly installed on the outlet of the tank and sealed in place.

This cycle continues until replacement of the tank is desired.

### Example 2

A sensory/taste and microbiological growth test was conducted. One bag was filled with high fructose corn syrup (HFCS) and one bag remained empty. Both units were attached to the 300-W heating unit with a temperature measuring device. The test assesses the biological stability and sensory of HFCS after a 6-month period. During the 6-month period, the unit was reheated to 85° F. and transferred into the other unit. Samples were taken after the trial for microbiological and sensory/taste tests. The test samples were compared to a control sample collected at the beginning of the trial and saved in a glass container. The test sample passed both microbiological and sensory/taste tests using the approved method for testing all HFCS.

### Example 3

An impact test was conducted to test the unit's ability to withstand the Association of American Railroads (AAR) required 2G force hitting the front of the container, opposite the doors. The AAR standard applies to all ISO containers, like the ones used for the large-scale model. A similar flexible bag from above was filled with water and placed inside the insulating container inside a small-scale transport container. The insulating container had an accelerometer attached to measure the force and straps to keep the insulating container lid closed. The unit received at least a 2G force nine times and up to an 8G force without structural cracking to the insulating container or flexible bag.

A number of embodiments of the invention have been described. Nevertheless, it will be understood that various modifications may be made without departing from the spirit and scope of the invention. Accordingly, other embodiments are within the scope of the following claims.

1. An apparatus for the transport of materials, comprising:
a tank having a top surface, a bottom surface, a cavity, and an access port;
a flexible bag comprising a check valve assembly, wherein the flexible bag can be positioned inside the cavity of the tank such that the check valve assembly is able to be accessed from the tank's access port;
an insulating shell adjacent to the tank;
a bulkhead assembly providing structural support to the tank; and
a temperature control unit for controlling the temperature of the materials.

2. The apparatus of claim 1, further comprising an outer shipping container.

3. The apparatus of claim 1, wherein the bulkhead assembly comprises a door.

4. The apparatus of claim 1, wherein the check valve assembly is removable.

5. The apparatus of claim 1, wherein the check valve assembly is washable.

6. The apparatus of claim 1, wherein the check valve assembly is sealable.

7. The apparatus of claim 1, wherein the check valve assembly is affixed to the bag.

8. The apparatus of claim 1, wherein the flexible bag is made from polypropylene, polyethylene, or other polymeric material.

9. The apparatus of claim 1, wherein the flexible bag has a single layer construction.

10. The apparatus of claim 1, wherein the flexible bag has a multi-layer construction.

11. The apparatus of claim 1, wherein the flexible bag holds 5,000 to 25,000 liters of fluid.

12. The apparatus of claim 1, wherein the flexible bag is reusable.

13. The apparatus of claim 1, wherein the flexible bag is recyclable.

14. The apparatus of claim 1, wherein the tank is rigid.

15. The apparatus of claim 1, wherein the tank is semi-rigid.

16. The apparatus of claim 1, wherein the insulating shell is permanently affixed to the tank.

17. The apparatus of claim 1, wherein the insulating shell is removably attached to the tank.

18. The apparatus of claim 1, wherein the insulating shell is flexible.

19. The apparatus of claim 1, wherein the insulating shell is rigid.

20. The apparatus of claim 1, wherein the temperature control unit comprises a heating mechanism.

21. The apparatus of claim 20, wherein the heating mechanism is a heating pad.

22. The apparatus of claim 20, wherein the heating mechanism is a plurality of heating pads.

23. The apparatus of claim 1, wherein the temperature control unit comprises a cooling mechanism.

24. A process for transporting material, comprising:
filling the flexible bag of the apparatus of claim 1 with a material via the check valve assembly;
placing the apparatus on a chassis;
transporting the apparatus to a delivery location; and
unloading the material from the flexible bag via the check valve assembly.

25. The process of claim 24, wherein said material is selected from the groups consisting of corn syrup, high fructose corn syrup, soybean oil, corn oil, and industrial oils.

26. An apparatus for transporting corn syrup, comprising:
a rigid tank having a top surface, a bottom surface, a cavity, and an access port located at or near the bottom surface;
a flexible bag comprising a check valve assembly, wherein the flexible bag can be positioned inside the cavity of the tank such that the check valve assembly is able to be accessed from the tank's access port;
a removable foam insulating shell applied to the exterior of the tank;
a bulkhead assembly providing structural support to the tank; and
a temperature control unit comprising one or more heating elements for controlling the temperature of the materials.

27. The apparatus according to claim 1, wherein the check valve assembly is selected from the group consisting of a one-way check valve and a block valve.

28. The apparatus according to claim 1, wherein the check valve assembly reduces contamination by providing a closed system.

29. The apparatus according to claim 1, wherein the check valve assembly reduces contamination by preventing back-flow.

30. The apparatus according to claim 1, wherein the flexible bag is sealed to reduce contamination.

31. The apparatus according to claim 1, wherein little or no air space is provided between the flexible bag and the bulkhead assembly to reduce contamination.
